(19) United States
(12) Patent Application Publication
(10) Pub. No.: US 2009/0216767 A1
(43) Pub. Date: Aug. 27, 2009

(54) Method And Device For Data Management

(76) Inventors: Petri Kotro, Helsinki (FI); Arto Astala, Vantaa (FI); Marko Makinen, Helsinki (FI); Jussi Saarelainen, Helsinki (FI); Olli Mannerkoski, Helsinki (FI)

Correspondence Address: LADAS & PARRY LLP, 26 WEST 61ST STREET, NEW YORK, NY, 10023, US

(21) Appl. No.: 12/087,531

(22) PCT Filed: Jan. 19, 2007
(86) PCT No.: PCT/FI2007/050028

§ 371 Date: Feb. 19, 2009

(30) Foreign Application Priority Data
Jan. 20, 2006 (FI) 20065039

(51) Int. Cl. G06F 17/30; G06F 3/048

(52) U.S. Cl. 707/7; 715/764; 707/E17.044; 707/102; 707/E17.005

(57) ABSTRACT

A method for data management and an electronic device comprising a memory for storing data items are provided. The device comprises a controller configured to determine a data set comprising a set of data items, determine the number of data items in the set, select the type of a display map on the basis of the number and type of data items in the data set, determine the number of area elements in the map on the basis of the data set, display on a display the display map comprising the determined number of area elements, and receiving from user interface data management commands related to the displayed map.

### FIELD

The invention relates to data management in devices comprising a memory for storing data items. Especially the invention relates to devices where the stored data items comprise metadata which may be used for sorting and grouping the data items.

### BACKGROUND

The usage of small portable multimedia players has increased in recent years. The development of technology has made it possible to produce devices with large amount of memory which are still small in size. Typically, these devices comprise a memory which may be integrated into the device or which may be detachable. Examples of integrated memories are small disc drives and memory circuits. Examples of detachable memories include memory cards.

Typical data types stored on these memories are music tracks, video tracks and images. Typical memory sizes vary from a few hundred kilobytes to several gigabytes. As the sizes of available memories have increased, it has become possible to store hundreds and even thousands of data items on a single memory or device.

Managing and accessing a large amount of data is a difficult task, especially when the device used to manage the data comprises a relatively small display, as is the case with portable multimedia players, for example. Typical solution of managing data is to display titles of the data items on the display as a scrollable list. Efficient data management using a scrollable list is very cumbersome when the number of displayed data items is large.

### BRIEF DESCRIPTION OF THE INVENTION

An object of the invention is to provide an improved solution for data management. According to an aspect of the invention, there is provided in a device comprising a memory for storing data items comprising metadata and a display, a method for data management, the method comprising determining a data set comprising a set of data items, determining the number of data items in the data set, selecting the type of a display map on the basis of the number and type of data items in the data set, determining the number of area elements in the map on the basis of the data set, displaying the display map comprising the determined number of area elements, receiving data management commands related to the displayed map.

According to another aspect of the invention, there is provided an electronic device comprising a memory for storing data items comprising metadata, a display, a user interface and a controller operationally connected to the display, the user interface and the memory, the controller being configured to determine a data set comprising a set of data items, determine the number of data items in the set, select the type of a display map on the basis of the number and type of data items in the data set, determine the number of area elements in the map on the basis of the data set, display on the display the display map comprising the determined number of area elements, receiving from the user interface data management commands related to the displayed map.

According to another aspect of the invention, there is provided a computer program product encoding a computer program of instructions for executing a computer process for data management, the process comprising: determining a data set comprising a set of data items, determining the number of data items in the set, selecting the type of a display map on the basis of the number and type of data items in the data set, determining the number of area elements in the map on the basis of the data set, displaying the display map comprising the determined number of area elements, receiving data management commands related to the displayed map.

According to yet another aspect of the invention, there is provided a computer program distribution medium readable by a computer and encoding a computer program of instructions for executing a computer process for data management, the process comprising: determining a data set comprising a set of data items, determining the number of data items in the set, selecting the type of a display map on the basis of the number and type of data items in the data set, determining the number of area elements in the map on the basis of the data set, displaying the display map comprising the determined number of area elements, receiving data management commands related to the displayed map.

The invention provides several advantages. When the number of data items is taken into account when selecting the data management user interface, the data management is easy and flexible regardless of the number of data items.

In an embodiment of the invention, the user interface comprises a map with a determined number of area elements. Depending on the number of data items, each area element represents a single data item or a group of data items. The data items may be grouped on the basis of metadata of the data items.

Data management commands related to the displayed map may be executed. The commands may comprise selecting, sorting, searching, zooming, deleting, and other commands.

The proposed solution is generic and suitable for a large range of devices and content types. It provides multilevel browsing with flexible and dynamic hierarchy and user-defined sorting and classification. In an embodiment, user interaction is specified for one hand use, so the user interface can be operated with a multi-button mouse, a mobile phone or a remote controller, for example. The solution enables short and intuitive browsing sequences. It also allows multiple paths to desired items, reducing cognitive load to the user as well as providing better discovery possibilities in shop-type applications. Unified browsing model allows multiple selections to include items of different types.

### LIST OF DRAWINGS

In the following, some aspects of the invention will be described in greater detail with reference to the embodiments and the accompanying drawings, in which

FIG. 1 shows an example of an electronic device of an embodiment of the invention;

FIG. 2 is a flowchart illustrating an embodiment of the invention;

FIG. 3 illustrates a layout of a data browser application;

FIG. 4 illustrates the rendering order of a data map;

FIGS. 5A and 5B illustrate area elements with different data item combinations;

FIGS. 6A and 6B illustrate the scalability of rendering a data map; and

FIGS. 7A and 7B illustrate a data viewer.

### DESCRIPTION OF EMBODIMENTS

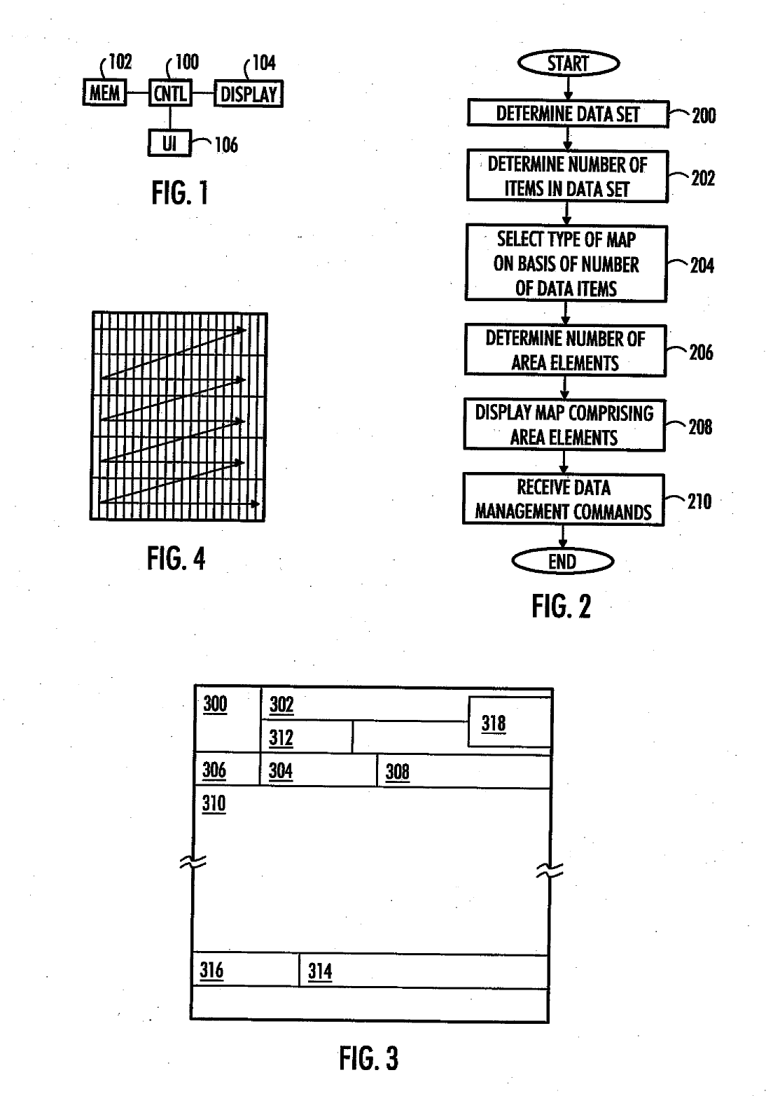

FIG. 1 illustrates an example of an electronic device which may be utilized in some embodiments of the invention. It should be noted that embodiments of the invention may be utilised in many kinds of electronic devices and the device of FIG. 1 is a generalised example of such a device. The electronic device may comprise several different aspects not disclosed in FIG. 1 for simplicity. Examples of such different devices include mobile phones, portable personal digital assistants (PDA's), portable computers, multimedia players, music players and imaging devices, among others.

The device comprises a controller 100 which controls the operation of the device. The controller 100 is typically implemented with a microprocessor, a signal processor or separate components and associated software. A memory 102 is connected to the controller. The memory may be realized with a small disc drive, memory circuits, or detachable memory cards, for example. The memory may also be realized with any combination of the above. Thus, the device may comprise one or more memory units.

The device comprises a display 104 connected to the controller used for displaying information to the user of the device. The device may further comprise user interface 106 connected to the controller. The user interface may comprise a keyboard, a joystick, a microphone, a speaker, or any other means with which the user of the device may give commands to the user. The user interface may also be realized with a touch sensitive display. Depending on the type of the device, there may be a different number of user interface parts.

The memory 102 is used for storing data items of different data types, such as music tracks, images, multimedia clips, playlists and text. The memory may also be used for storing software and other relevant data utilised by the controller, such as properties of the media player application of the device. Such properties may be effects available in the media player and preset effect settings. In an embodiment, the stored data items comprise metadata. The metadata is additional information stored in the data item. The additional information may relate to different properties of the data item. For example, when the data type of a data item is a music track, the metadata may comprise information about the artist performing the track, the album the track belongs to, genre of the music track, length of the track, rating of the track, publishing year, publisher, file format, the number of times the track has been played recently, the last date and time the track has been played, record label, purchase date, remixer of the track and producer of the track.

It should be noted that the previous list of data types stored in the memory 102 is non-exhaustive. Embodiments of the invention are not limited to any particular data type.

The number of data items which may be stored in the memory 102 depends on the size of the memory and the size of the data items. The number may vary from a few to thousands of data items. Data items of different types may be simultaneously stored in the memory.

In an embodiment, the invention is utilised in a data browser application. The data browser application may be an application executed by the controller 100 and it may be used to manage data stored in the memory 102. The data browser application may be a standalone application or it may be integrated into another application, such as a multimedia player.

In an embodiment of the invention, the data management of the data items is performed using a map displayed on the display 104 of the device. The map comprises area elements which represent one or more data items stored in the memory. The user of the device may perform data management commands to desired data items by selecting the area elements and executing the desired command.

FIG. 2 is a flowchart illustrating an embodiment of the invention. FIG. 3 illustrates a layout of a data browser application which is displayed on the display 104. In following, embodiments of the invention are illustrated referring to FIGS. 2 and 3 and assuming that the memory 102 comprises music related data items, such as music tracks and playlists.

In step 200, a data set comprising a set of data items is determined. The data set comprises the part of the data items stored in the memory 102 that the user wishes to manage. When a data browser application is initiated, the data browser may have a default data set. The default data set may be all playlists stored in the memory 102, for example.

In an embodiment, the data set may comprise data items of one data type from one memory unit. Thus, the user may manage all music tracks at the same time. To manage playlists, a new data set must be determined. In another embodiment, the data set may comprise data items of different types. Thus, the user may manage all music tracks and images at the same time, for example.

The user may determine a new data set at any time. In step 200, a new data set selection is performed. The layout of the data browser application comprises a data location indicator-field 300 in which the memory unit in which the determined data set is stored is indicated. The layout also comprises a field 302 where a description of the determined data set is displayed as text. For example, if the data set comprises all music tracks of a given memory unit, the field might display a text “Songs”. If the data item type is playlist, and all playlists are displayed, the field might display “Playlists”. If the determined data set comprises a selection or a group of data items of a given type, the name of the group is displayed in the field 302.

In step 202, the number of data items in the determined data set is calculated. For example, if the data set comprises music tracks from a given memory unit, the number of music tracks belonging to the set is calculated.

In step 204, the type of a display map is selected on the basis of the number and type of data items in the data set. To enable the user to manage data items, a map comprising area elements is to be displayed on the display 104. In this embodiment of the invention, the number of data items in the data set has an effect on how the display map is created. For example, if the number of data items in the data set is equal or below a predetermined threshold, a map type where each area element of the map represents a single data item is selected. In this case the type of the map may be called a single map. Respectively, if the number of data items in the data set is above a predetermined threshold, a map type where each area element of the map represents one or more data items is selected. In this case the type of the map may be called an area map.

Thus, when the number of the data items in the data set is small, each area element represents a single data item. When the number of the data items is large, it is easier to the user to overview the whole data set if each area element on the map represents several data items. Thus, the number of area elements on the screen may be kept such that all area elements may be shown on the display at the same time. The user has no need to scroll the map in any direction. If the user wishes to have access to individual data items, the user may select an area element representing a group of data items and zoom into the area element after which a new map is displayed on the screen. In the new map, the area elements represent the data items of the selected group. Zooming will be explained in more detail later.

In an embodiment, the predetermined threshold used in selecting the map type depends on the type of the data items in the data set. Thus, if the data type of the data items is a single content file, such as a music track or an image, the threshold may be different compared to a situation when the data type of the data items is a playlist, for example.

The following table represents an example of possible values of the predetermined threshold for different data item types:

| Type of data item | Threshold |
|---|---|
| A single content file (music track) | 210 |
| Playlist | 48 |
| Preset effect setting | 48 |

The above values may depend on the size of the display and other possible features available in the user interface. The values in the table are suitable for the display of S60 mobile phones.

In step 206, the number of area elements in the map is determined on the basis of the data set. In the case of a single map, the number of area elements corresponds to the number of data items. In the case of area map, the data items must be divided into different groups, and each area element represents a group.

In an embodiment, the data items are sorted into a given order on the basis of given criteria. The user may select a desired sorting method. The layout of the data browser application comprises fields 304, 306, 308 for controlling the sorting. The field 304 is a sorting menu, where the sorting key may be selected. The field 306 is a sorting menu item count indicator, displayed only if more than 10 sorting menu items exist. The field 308 displays the active sorting menu item. The sorted data items are grouped in one or more groups on the basis of the sorting. Each group is associated with an area element of the display map.

In an embodiment, the sorting and grouping is based on available metadata of the data items. The following table illustrates an example of sorting and grouping methods for single content files (music track) based on their metadata:

| Metadata | Sorting | Grouping |
|---|---|---|
| Track name | Alphabetical order. | Alphabetical grouping based on first letter |
| | | of the track name. The tracks whose |
| | | names start with a given letter form a group. |
| Artist | Alphabetical order. | Alphabetical grouping based on first |
| | | letter of the artist. The artists whose |
| | | names start with a given letter form a |
| | | group and the tracks of these artists |
| | | belong to this group. |
| Albums | Alphabetical order. | Alphabetical grouping based on first |
| | | letter of the album name. The albums |
| | | whose names start with a given letter |
| | | form a group and the tracks of these |
| | | albums belong to this group. |
| Genre | Alphabetical order. | Genre name. The tracks that belong |
| | | to a specified genre belong to this group. |
| Track | Time order based on the | Group per time value with a specified |
| length | length of the track starting | threshold. |
| | from the shortest one. | |
| Rating | Numerical order based | Group per ranking value and unrated. |
| | on the rating value of the | For example: 5 stars, 4 stars, 3 stars, |
| | tracks starting from the | 2 stars, 1 star and unrated. |
| | highest value. | |
| Play count | Numerical order based | Group per popularity value with a |
| | on the times the tracks | specified threshold. |
| | have been played starting | |
| | from the most played. | |
| Last play | Date order based on the | Group per time intervals: This week, |
| date | last play date of the tracks | Last week, month/year groups, unknown. |
| | starting from the latest one. | |
| Publishing | Year order based on | Group per year, unknown. For example, |
| year | publishing year of the | 1956, 1958, 1960, 1961, . . . , unknown. |
| | tracks starting from the | |
| | latest one. | |
| Publisher | Alphabetical order | Alphabetical grouping based on first |
| | | letter of the publisher's name. |
| Label | Alphabetical order | Alphabetical grouping based on first |
| | | letter of the label name. |
| File format | Alphabetical order | File format name. |
| Purchase | Date order starting from | Group per time intervals: This week, |
| date | the latest one. | Last week, month/year groups, not |
| | | purchased. Similar to last play date. |
| Remixer | Alphabetical order | Alphabetical grouping based on first |
| | | letter of the remixer's name. |
| Producer | Alphabetical order | Alphabetical grouping based on first |
| | | letter of the producer's name. |

The same sorting and grouping principles may be applied when the data items are of a different data type, such as playlists or effect presets. The sorting method may also have a secondary sorting key. For example, when several tracks belong to the same artist, track name sorting may be used between them.

When the data items have been grouped into different groups, the number of area elements may be determined. Each area element represents a group. However, empty groups are not associated with any area element. Thus, if the current data set does not have any data items for a certain group, the area element for the group is not drawn on the map. So, the number of area elements on the map depends on both the grouping method defined by sorting and grouping method and the current data set.

In step 208, the map comprising the determined number of area elements is displayed on the display. The layout of the data browser application comprises a field 310 for displaying the map. In the case of a single map, the number of area elements corresponds to the number of data items. In the case of an area map, the number of area elements corresponds to the number of groups. The number and semantics of the area elements depend on the sorting and grouping method. For example, if the sorting method is the alphabetical order based on the track name, the grouping method is alphabetical groups based on the first letter of the track name. All groups that are formed are drawn on the map as area elements in the order defined by the current sorting method.

In an embodiment, the size of each area element is relative to other area elements on the map and it is calculated dynamically. In an embodiment, the height of each area element is constant but the width is dynamic. If the element is too wide to fit on a single line, it may continue to another line. The area map always represents 100% of the data set which is defined by type, location and zooming and/or keyword search. In an embodiment, the size of an area element represents the relative amount of data in the group compared to the whole data set. There may be different visual indicators for area elements based on the data type.

When an area map is used, nothing can be selected but the user may zoom into a group. The map is re-rendered if zoom or search operation is performed or if sorting method, data type or location is changed.

When the map type is a single map each area element on the map represents a unique data item. The number of area elements on the map equals the number of data items in the data set. The area elements are rendered to the map in the order defined by the selected sorting method. The size of the single element depends on the number of columns and rows used for rendering the map, and this depends on the number of data items in the current data set. There may be different visual indicators for area elements based on the data type of the data items.

In step 210, data management commands related to the displayed map are received. The commands may comprise selecting, sorting, searching, zooming, deleting, and other commands. Using the user interface of the device the user may select one or more area elements by setting a focus on one or more area elements. When a focus is set on an area element, the element or elements may be highlighted.

When an area map is used, nothing can be selected but the user may zoom into a group. The map type may change to a single map type in such a case. The map is re-rendered if zoom or search operation is performed or if sorting method, data type or location is changed.

Selecting data items is possible when a map of a single type is displayed.

In the following, the rendering and displaying of the map comprising area elements is explained in more detail.

In an embodiment, the rendering of the map comprising area elements is based on a grid, which is defined by columns and rows. FIG. 4 illustrates the rendering order of the data map. The order of data items rendered to the map is left-to-right and top-to-bottom starting from the top left corner of the map. The first item is at the top left corner of the map. Typically the map is not scrollable—it always visualises the current data set totally in one view.

The same rendering order is used with all data types with both area and single map types. Otherwise, the rendering of different data items is done as specified next.

First, let us assume that the map type is an area map and that the data set comprises single content files (music tracks, for example). In an embodiment, the map is rendered to a grid, which has 20 columns and 5 rows. This equals 100 cells. The width of the columns and the height of the rows shall be equally distributed based on the size of the map area. The cells are of the same size. The size of the data map grid is 172×130 pixels, which means that the map row height is 26 pixels and the column width 8.6 pixels. One cell is then 8.6×26 pixels. It should be noted that the numerical values are merely examples of possible values. Variations in these numerical values are possible as is known to one skilled in the art.

Each cell of the map represents 1% of the whole map. Each area element may comprise one or more cells. Thus, the cells may be called building blocks of the area elements. The relative size of each area element is calculated based on the total number of data items in the current data set, and the calculated percentage is used for rendering the area element to the map (left-to-right, top-to-down, in the order of the sorting method). If there is a group (based on the sorting/grouping method) that holds less than 1% of the total amount of data, it is rounded up to 1%.

Let us study an example. A data set comprises 5,000 music tracks. The selected sorting method is the track name, which defines that the grouping method is alphabetical based on the first letter of the track name. Now, all those alphabets that do not have any songs with a name starting with those alphabets are ignored. Let us assume that we have 20 groups (group ‘A’, group ‘C’, group ‘D’, etc . . . ). The number of data items (tracks) in each group is compared to the number of all songs in the current data set in order to calculate a relative size value for the group. After this is done the groups are rendered with area elements with defined sizes in the order defined by the sorting method. For example, if the content of a group is 12% of the content of the current data set, the group is rendered with an area element that takes 12% (12 cells) of the map area.

There is no margin between cells which belong to same group, but there is a margin of 1 pixel between group areas. If the area element continues to the next row a cut indication is used.

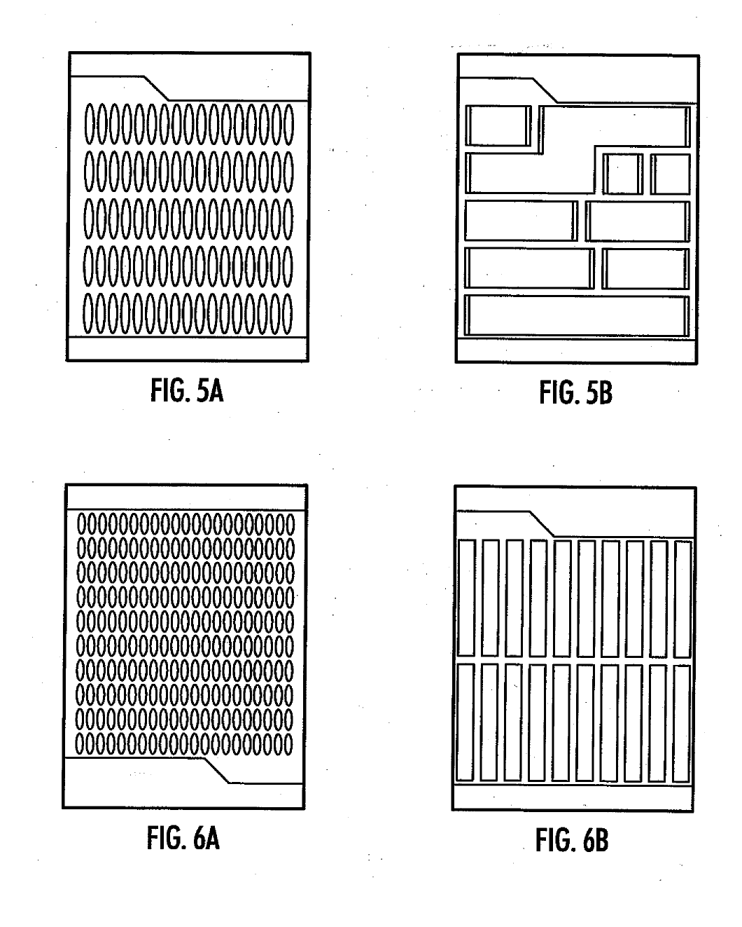

FIGS. 5A and 5B illustrate area elements with different data item combinations. In FIG. 5A each area element represents 1% of data set. Thus, each area element is the size of a single cell. In FIG. 5B the area elements from left to right, top to bottom represent the following amounts of total data: 5%/25%/3%/15%/12%/10%/10%/20%.

Next, let us assume that the map type is a single map. In an embodiment a map of a single map type comprising single content files (music tracks, for example) is rendered to a grid which has no more than 21 columns and no more than 10 rows. Thus, the maximum number of cells on the grid is 210. The map grid is drawn to fill up the whole map area 310. In an embodiment, the map area is of the size 172×130 pixels. The number of columns and rows used for rendering the map in each case is dynamical and depends on the number of data items in the current data set. The number of columns and rows used defines the size of the cells in the grid, and the data item indicator is rendered to a size of the grid cell. Thus, less data leads to bigger data indicators and more data leads to smaller data indicators. The minimum number of columns in the map grid is 6and the minimum number of rows is 2. The range of columns in a single content file map grid is 6 to 21 and the range of rows is 2 to 10. Based on this the range of the cell size in pixels is from 8×13 pixels to 28×65 pixels. Remainders are dropped from the bottom of the map grid. If the grid does not fill up exactly with single data elements it is left blank from the end on the basis of the rendering order.

The following table shows an example of how the number of columns and rows used for rendering the map grid on the basis of the number of data elements in the current data set may be defined. The grey area on the left defines the number of columns, the grey area on top defines the number of rows and the numbers inside the table show the number of data items at the current data set. Thus, if there are 96 data elements to be drawn, the map is rendered in 7 rows and 14 columns.

| | 10 | 9 | 8 | 7 | 6 | 5 | 4 | 3 | 2 |
|---|---|---|---|---|---|---|---|---|---|
| 21 | 210-201 | | | | | | | | |
| 20 | 200-191 | | | | | | | | |
| 19 | 190-181 | | | | | | | | |
| 18 | 180-171 | | | | | | | | |
| 17 | 170-161 | | | | | | | | |
| 16 | 160-151 | 144-136 | | | | | | | |
| 15 | 150-145 | 135-127 | 120-113 | 105-99 | 90-85 | | | | |
| 14 | | 126-121 | 112-106 | 98-92 | 84-79 | | | | |
| 13 | | | | 91 | 78-73 | 65-61 | | | |
| 12 | | | | | 72-67 | 60-56 | | | |
| 11 | | | | | 66 | 55-51 | | | |
| 10 | | | | | | 50-46 | 40-37 | | 20-19 |
| 9 | | | | | | 45-41 | 36-33 | | 18-17 |
| 8 | | | | | | | 32-29 | | 16-15 |
| 7 | | | | | | | 28-26 | 21 | 14-13 |
| 6 | | | | | | | 24-22 | | 12-11 |

In an embodiment, if the current data set is less than 10 items, the map is not rendered but the items are displayed with a text list.

FIGS. 6A and 6B illustrate the scalability of rendering when single content files are displayed using a map of a single map type. In FIG. 6A, 210 data items are displayed, whereas in FIG. 6B the number of data items is 20.

In an embodiment, a fixed data map grid with a single map type is utilised when the data set comprises playlists and effect presets. The data map grid has 6 columns and 8 rows. Thus, the number of cells is 48. The width of the columns and the height of the rows are equally distributed based on the size of the map area (all cells are of same size). The width of the column is 28 pixels and the height of the row 16 pixels.

The graphic elements representing a playlist and a preset are not scalable. The elements are rendered to the grid in a defined drawing order. If there are less than 48 items the rest of the map remains empty. If there are more than 48 items the area map type is used. Again, the mentioned numerical values are merely examples of a multitude of possible values.

In the following, zooming is explained in more detail. Zooming the data map means that the current data set is limited to the group of data items that are included in the zoomed area. Zooming can be done when the area map type is used. The groups that can be zoomed are built upon the grouping method defined by the sorting method. Changing the sorting method rearranges the groups.

When the user has activated a group (an area element) from an area type data map by setting focus on the group he can zoom into that group. The current data set is automatically limited to the data items belonging to that group. The current data set indicator field 302 of the layout of the data browser is updated. The data map is re-rendered in order to visualize the updated data set. If the re-rendered data map is again of an area type, the user can zoom again into a selected group and filter the data set to a smaller number of data items. The number of zoom levels is not limited. The current zoom level is indicated in a zoom level indicator field 312 below the indication 302 of the current data set in the layout of the data browser.

Having zoomed in, the user can, using the user interface, also zoom back to the previous level by executing a command. There may also be a “rescue” function in the command set of the device, which takes the user directly back to the beginning (the first level from where the zooming started). When zoomed back the current data set is updated: expanded back to the zoom level or content group.

In an embodiment, the data browser application is configured to execute a data viewer which displays partial metadata of the data item or items associated with the area element currently in focus. The data viewer may display the metadata as a text window on the data map. The data viewer may also display images, such as thumbnails of images if the data browser application is used for images, or it might playback a preview clip of a song if the data browser application is used for music tracks. In an embodiment, the user may choose the type of data displayed by the data viewer. The data viewer display is integrated into the focus in the map; it moves along with the focus and displays the metadata of the data item or items associated with the area element that is in focus (highlighted). The data viewer window may comprise either one row for text labels or several rows for text labels.

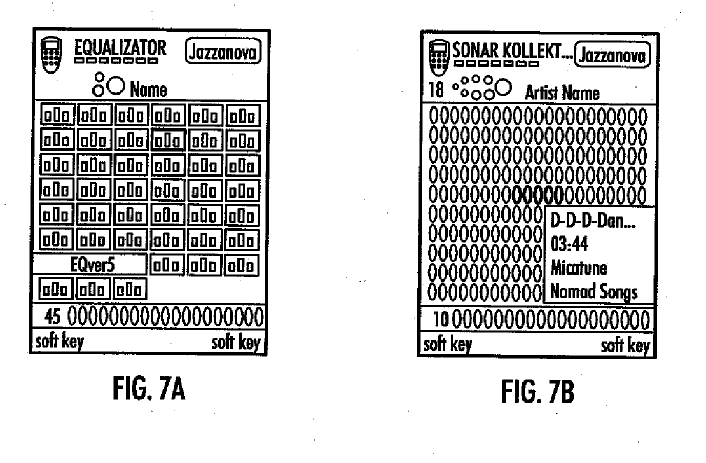

FIGS. 7A and 7B illustrate the data viewer. In FIG. 7A, the data viewer window comprises one row and in FIG. 7B the data viewer window comprises four rows.

The data viewer window is preferably placed in such a manner that one of its corners touches the edge of the data element in focus and that the whole data viewer is visible on screen.

When a data viewer is utilised, the data browser is configured to read the metadata of the data item or items associated with the area element obtaining focus. Then, the data browser is configured to select items from the metadata and display the partial metadata in a window. The data browser may select different metadata sets based on the data type, the data map type and the current sorting method.

For example, when the area map type is utilised, the selected metadata may comprise the name of the group or characters defining the group on the basis of the grouping method and the number of data items underneath the group. This may apply regardless of the data item type.

When the map type is a single map, and the data item type is single content file (such as a music track, for example), the selected metadata may vary depending on the current sorting method. The following table illustrates some examples:

| Sorting | |
|---|---|
| key | Selected metadata |
| Track | Name of the track and name of the artist of the track in focus, |
| name | and names of the tracks of previous and next items on map. |
| Artist | Name of the artist and name of the track in focus, and names |
| | of the artist of previous and next items on map. |
| Album | Name of the album, name of the artist and name of the track in |
| | focus, and names of the album of previous and next items on |
| | map. |

The following table illustrates some examples when the data type is a playlist and the map type is a single map:

| Sorting key | Selected metadata |
|---|---|
| Name | Name of the playlist in focus, total playback length of the |
| | playlist and number of single content files in the playlist. |
| Title | Title of the playlist in focus, total playback length of the |
| | playlist and number of single content files in the playlist. |
| Popularity | Name or Title of the playlist in focus, popularity value of |
| (play count) | the playlist, total playback length of the playlist and |
| | number of single content files in the playlist. |

In an embodiment, the data browser application is configured to receive multiple selections. The layout of the data browser comprises a multiselect indicator 314 which provides access for the (multi)selected data items, all at once. The layout of the data browser further comprises a field 316 for a multiselect item count indicator which displays the number of items currently selected. Items may be selected one data type at a time and they may be collected from different data maps and text lists.

As the user selects data items from single data maps and text lists, the selected data items are collected to the field 314. The field is filled up item by item when the items are selected. The selected items are also indicated in the data map area 310 as coloured items. When the desired items have been selected, actions and operations may be performed for all selected items at once (for example: purchase, add to playlist, play, etc . . .). The user may also zoom into the multiselect area, when the items in the area are visualised on the data map. When the selected items are visualised on the map, the user may remove items from the selection.

The selected items remain in the field 314 and remain selected until the user clears the multiselect area or removes single items. The selection is not automatically cleared after a possible action or operation. This way the user may assign several actions to the items, and even update the selection in between. The selection may also be saved and loaded again later.

In an embodiment, the data browser application is configured to search data items from the data set on the basis of keywords. The search procedure may be activated from the user interface 106 by pressing alphanumeric keys, for example. When search procedure is activated the data browser application is configured to query for keyword characters. The keyword characters given by the user are displayed in the search key field 318 of the layout of the data browser application.

In order to fasten up the search process the search covers only the current data set. This means that the search searches data only from a selected location, only in a selected type and if the user has zoomed into a data group, only within that group.

In an embodiment, the search is addressed to all text (metadata) fields. The search is based on calculation of a ‘match’ value. The match value may have values in the range of 0.0-100.0%.

For example, the user of the application enters a search key ‘house’, and the data type is single content files (music tracks), data location is local storage, and the user has not zoomed in a data map (the current data set is all songs in local storage). The search searches matches from all text fields and can find for example the following:
Adonis: No way back [genre=house], match 100%
Crowded house: Song [genre=rock], match ˜90%
Madness: My house [genre=ka], match ˜90%
Housemartins: Flag day [genre=rock], match ˜80%.

After the search has been processed, the data map is re-rendered based on the search results by using the following sorting and grouping order:
Sorting: Match value, starting from the highest value
Grouping: Groups based on match value, starting from the highest value group [100.0-90.1, 90.0-80.1, 80.0-70.1, 70.0-60.1, 60.0-50.1, 50.0-40.1, 50-0-30.1, 30.0-20.1, 20.0-10.1, 10.0-0.1].

If the match value for the data is 0.0, it means zero match. This data is cut off from the current data set.

In another example the user enters a search key ‘rock’, and the data type is playlists and data location local storage, no zooming has been done. The search is addressed to all text fields of a playlist data item and also to the music tracks within the playlist. If then a playlist is found that includes 7 out of 10 songs that match to [genre=rock], the playlist gets a match value of 70%.

The current data set is updated with the search results. The search key affects the current data set from now on until a new search is processed (redefining the search key) or the search key is removed. One search key can have multiple characters. If the user activates a search when there is already a search key the search key is displayed in a text input dialogue and the user may redefine the search key or change it to something else (or clear the key and run the search with an empty key which means the same as removing the search key). The search key can be removed through a command in the user interface.

After re-rendering the data map on the basis of a search the map may be operated normally, including zooming and sorting. The search result sorting (based on match value) updates dynamically the sorting menu, adding itself into it. When the user selects another sorting method for the current data set (which is defined also by the search key) for rearranging the data on the map, he/she can go back to the search result sorting again.

The embodiments of the invention may be realized in an electronic device comprising a display, user interface and a controller operationally connected to the keyboard and the display. The controller may be configured to perform at least some of the steps described in connection with the flowchart of FIG. 2 and in connection with FIGS. 3 to 7B. Embodiments may be implemented as a computer program comprising instructions for executing a computer process for data management, the process comprising: determining a data set comprising a set of data items, determining the number of data items in the set, selecting the type of a display map on the basis of the number and type of data items in the data set, determining the number of area elements in the map on the basis of the data set, displaying the display map comprising the determined number of area elements, receiving data management commands related to the displayed map.

The computer program may be stored on a computer program distribution medium readable by a computer or a processor. The computer program medium may be, for example but not limited to, an electric, magnetic, optical, infrared or semiconductor system, device or transmission medium. The computer program medium may include at least one of the following media: a computer readable medium, a program storage medium, a record medium, a computer readable memory, a random access memory, an erasable programmable read-only memory, a computer readable software distribution package, a computer readable signal, a computer readable telecommunications signal, computer readable printed matter, and a computer readable compressed software package.

Even though the invention has been described above with reference to the example according to the accompanying drawings, it is clear that the invention is not restricted thereto but it can be modified in several ways within the scope of the appended claims.

1. In a device comprising a memory for storing data items comprising metadata and a display, a method for data management, the method comprising:
determining a data set comprising a set of data items;
determining the number of data items in the data set;
selecting the type of a display map on the basis of the number and type of data items in the data set;
determining the number of area elements in the map on the basis of the data set;
displaying the display map comprising the determined number of area elements; and
receiving data management commands related to the displayed map.

2. The method of claim 1, the step of selecting the type of a display map further comprising:
selecting a map type where each area element of the map represents a single data item if the number of data items in the data set is equal to or below a predetermined threshold; and
selecting a map type where each area element of the map represents one or more data items if the number of data items in the data set is above a predetermined threshold.

3. The method of claim 2, wherein the predetermined threshold depends on the type of the data items in the data set.

4. The method of claim 2, further comprising:
sorting the data items to a given order on the basis of given criteria, grouping the data items in one or more groups on the basis of the sorting; and
associating each group with an area element of the display map when the number of data items in the data set is above a predetermined threshold.

5. The method of claim 4, further comprising: performing the sorting and grouping of the data items on the basis of metadata of the data items.

6. The method of claim 2, further comprising: calculating the size of each area element on the basis of the number of cells in the display map.

7. The method of claim 2, further comprising: calculating the size of each area element on the basis of the number of cells in the display map and the relative number of data items compared to the number of all data items in the selected data set.

8. The method of claim 1, further comprising:
detecting an area element obtaining focus, the area element representing a data item;
reading metadata of the data item;
selecting a portion of the metadata; and
displaying the selected metadata.

9. The method of claim 8, further comprising:
reading metadata of data items represented by area elements on both sides of the area element obtaining focus;
selecting a portion of the metadata; and
displaying the metadata along with the metadata of the data item represented by the area element obtaining focus.

10. An electronic device comprising a memory for storing data items comprising metadata, a display, a user interface and a controller operationally connected to the display, the user interface and the memory, the controller being configured to:
determine a data set comprising a set of data items;
determine the number of data items in the set;
select the type of a display map on the basis of the number and type of data items in the data set;
determine the number of area elements in the map on the basis of the data set;
display on the display the display map comprising the determined number of area elements; and
receive from the user interface data management commands related to the displayed map.

11. The device of claim 10, the controller being further configured to:
select a map type where each area element of the map represents a single data item if the number of data items in the data set is equal to or below a predetermined threshold, and
select a map type where each area element of the map represents one or more data items if the number of data items in the data set is above a predetermined threshold.

12. The device of claim 10, the controller being further configured to:
detect an area element obtaining focus, the area element representing a data item,
read metadata of the data item from a memory,
select a portion of the metadata, and
display the selected metadata on the display.

13. The device of claim 10, the controller being further configured to:
read from a memory metadata of data items represented by area elements on both sides of the area element obtaining focus,
select a portion of the metadata, and
display on the display the metadata along with the metadata of the data item represented by the area element obtaining focus.

14. A computer program product encoding a computer program of instructions for executing a computer process for data management, the process comprising:
determining a data set comprising a set of data items;
determining the number of data items in the set;
selecting the type of a display map on the basis of the number and type of data items in the data set;
determining the number of area elements in the map on the basis of the data set;
displaying the display map comprising the determined number of area elements; and
receiving data management commands related to the displayed map.

15. A computer program distribution medium readable by a computer and encoding a computer program of instructions for executing a computer process for data management, the process comprising:
determining a data set comprising a set of data items;
determining the number of data items in the set;
selecting the type of a display map on the basis of the number and type of data items in the data set;
determining the number of area elements in the map on the basis of the data set;
displaying the display map comprising the determined number of area elements; and
receiving data management commands related to the displayed map.

16. The computer program distribution medium of claim 15, the distribution medium including at least one of the following media: a computer readable medium, a program storage medium, a record medium, a computer readable memory, a computer readable software distribution package, a computer readable signal, a computer readable telecommunications signal, and a computer readable compressed software package.
